(19) United States
(12) Patent Application Publication
(10) Pub. No.: US 2025/0280760 A1
(43) Pub. Date: Sep. 11, 2025

(54) BACK UP AID FOR RIDE-ON EQUIPMENT

(71) Applicant: Bemis Manufacturing Company, Sheboygan Falls, WI (US)

(72) Inventors: Timothy Wilhelm, Sheboygan Falls, WI (US); Jonathan Simpson, Sheboygan Falls, WI (US)

(21) Appl. No.: 19/071,536

(22) Filed: Mar. 5, 2025

Related U.S. Application Data
(60) Provisional application No. 63/561,546, filed on Mar. 5, 2024.

(51) Int. Cl. A01D 34/82; A01D 34/64; A01D 101/00

(52) U.S. Cl. CPC A01D 34/828; A01D 34/64; A01D 2101/00

(57) ABSTRACT

A back up system for ride-on equipment includes a plurality of back up sensors configured to sense an object within a back up region of the ride-on equipment, a deterrence device configured to emit a sound, a display configured to display the sensed object, and a controller configured to: determine whether the sensed object is within the back up region based on feedback from the plurality of back up sensors, and activate, in response to determining that the object is within the back up region, the deterrence device and the display.

### CROSS-REFERENCE TO RELATED APPLICATIONS

This application claims priority to U.S. Provisional Patent Application No. 63/561,546, filed Mar. 5, 2024, the entire content of which is incorporated herein by reference.

### FIELD OF THE DISCLOSURE

The present disclosure relates to back up aids for ride-on equipment, and, more specifically, to back up aids for detecting objects or beings behind the ride-on equipment and alerting an operator.

### SUMMARY

In some aspects, the techniques described herein relate to a back up system for ride-on equipment including: a plurality of back up sensors configured to sense an object within a back up region of the ride-on equipment; a deterrence device configured to emit a sound; a display configured to display the sensed object; and a controller configured to: determine whether the sensed object is within the back up region based on feedback from the plurality of back up sensors, and activate, in response to determining that the object is within the back up region, the deterrence device and the display.

In some aspects, the techniques described herein relate to a back up system for ride-on equipment including: a sensor configured to sense an object within a back up region of the ride-on equipment; a deterrence device configured to emit a sound; an indicator; and a controller configured to: determine whether the sensed object is within the back up region based on feedback from the sensor, and activate, in response to determining that the object is within the back up region, the deterrence device and the indicator.

In some aspects, the techniques described herein relate to a back up system for ride-on equipment including: a plurality of back up sensors configured to sense an object within a back up region of the ride-on equipment the plurality of back up sensors including at least one infrared (IR) sensor; a deterrence device configured to emit sound waves in a frequency range from 17,000 Hz to 19,000 Hz; and a controller configured to: determine whether the sensed object is within the back up region based on feedback from the plurality of back up sensors, determine whether the sensed object is a living being based on feedback from the IR sensor. activate, in response to determining that the object is within the back up region and that the object is a living being, the deterrence device.

Other aspects of the disclosure will become apparent by consideration of the detailed description and accompanying drawings.

### BRIEF DESCRIPTION OF THE DRAWINGS

FIG. 1 is a schematic illustration of ride-on equipment including a back up system embodying aspects of the present disclosure.

FIG. 2 is a schematic illustration of the ride-on equipment of FIG. 1, illustrating detection of an object by back up system.

FIG. 3 is schematic illustration of a deterrence device of the ride-on equipment of FIG. 1, according to some aspects and examples.

FIG. 4 is a schematic illustration of a display of the ride-on equipment of FIG. 1, according to some aspects and examples.

FIG. 5 is a schematic illustration of the display of the ride-on equipment of FIG. 1, indicating a location of an objected detected by the back up system.

FIG. 6 is a schematic illustration of the display of the ride-on equipment of FIG. 1, indicating a location of a living being detected by the back up system.

FIG. 7 is a block diagram of a controller for the ride-on equipment of FIG. 1, according to some aspects and examples.

FIG. 8 is a flow chart of a first method of operation of the back up system of the ride-on equipment of FIG. 1.

FIG. 9 is a flow chart of a second method of operation of the back up system of the ride-on equipment of FIG. 1.

FIG. 10 is a plan view of a deterrence device usable with the ride-on equipment of FIG. 1.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

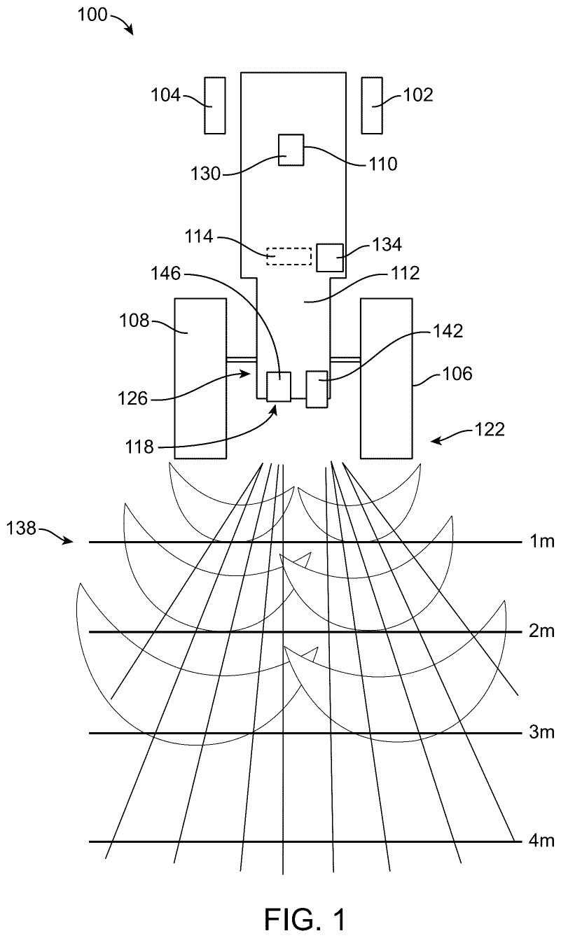

FIG. 1 illustrates an example of ride-on equipment 100 in the form of a lawn mower. The equipment 100 may include a rotating blade for cutting a lawn to a desired height. In other embodiments, the equipment 100 may additionally or alternatively include a tool for sweeping debris, vacuuming debris, clearing debris, collecting debris, moving debris, etc. Debris may include plants (such as grass, leaves, flowers, stems, weeds, twigs, branches, etc., and clippings thereof), dust, dirt, jobsite debris, snow, or any other outdoor lawn or landscape debris. In the illustrated embodiment, the equipment 100 is a sitting ride-on lawn mower. In other embodiments, the equipment 100 may be a standing ride-on lawn mower, zero-turn mower, etc. The equipment 100 may be autonomous, semi-autonomous, or not autonomous. In yet other embodiments, the equipment 100 may include any other ride-on equipment configured to move while carrying an operator, such as offroad vehicles, powersport equipment, ATVs, UTVs, forklifts, maintenance, or landscaping equipment.

The illustrated equipment 100 includes a right front wheel 102, a left front wheel 104, a right rear drive wheel 106, a left rear drive wheel 108, a chassis or frame 110, an operator platform or seat 112 coupled to the frame 110 and configured to support an operator driving the equipment 100, and a control unit 114, which may include levers, joysticks, a steering wheel, or the like used to control operation of the equipment 100. The equipment 100 is drivable in a forward direction and a rearward or reverse direction. The equipment 100 further includes a back up system 122 configured to detect objects and living beings (i.e., people and animals) proximate the equipment 100 and provide information/warnings regarding detected objects and living beings to an operator of the equipment 100. For example, as described in greater detail below, the illustrated back up system 122 includes one or more back up sensors 126 configured for detecting the presence and location of objects and living beings within a field of view of the back up sensors 126 and an indicator, such as a display 134, for displaying the sensed objects and living beings to the operator. The illustrated back up system 122 may additionally or alternatively include a deterrence device 130 configured to deter living beings from a path of the equipment 100, as described in greater detail below.

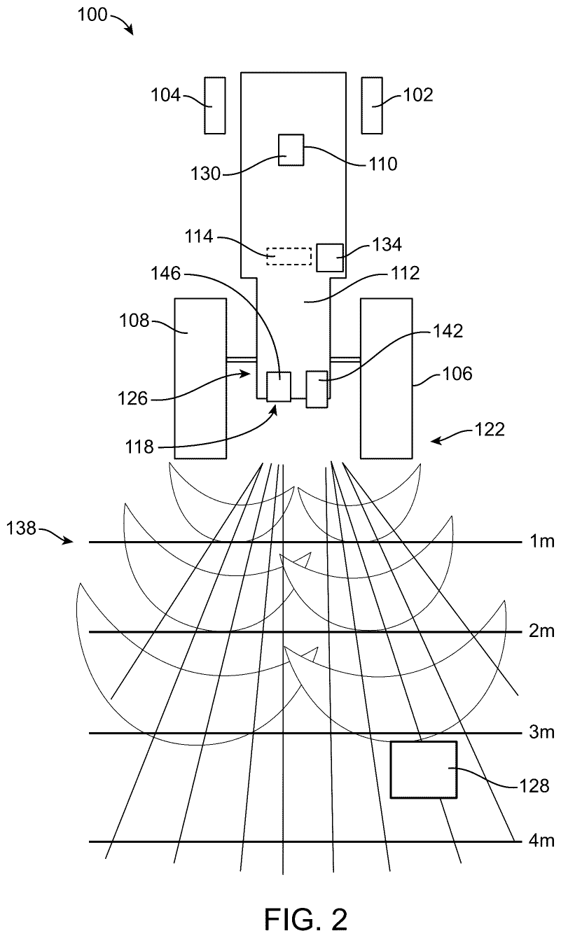

With reference to FIGS. 1 and 2, the frame 110 includes a rear portion 118 configured for mounting the back up sensors 126. The back up sensors 126 are configured to detect objects or living beings that come within a projected back up region 138 of the equipment 100. In some embodiments, the back up region 138 is an approximately 16 square meter region behind the equipment 100. For example, the back up region 138 may be approximately 4 meters long and 4 meters wide. In alternate embodiments, the back up region 138 may vary in size (e.g., depending on the size and speed of the equipment 100).

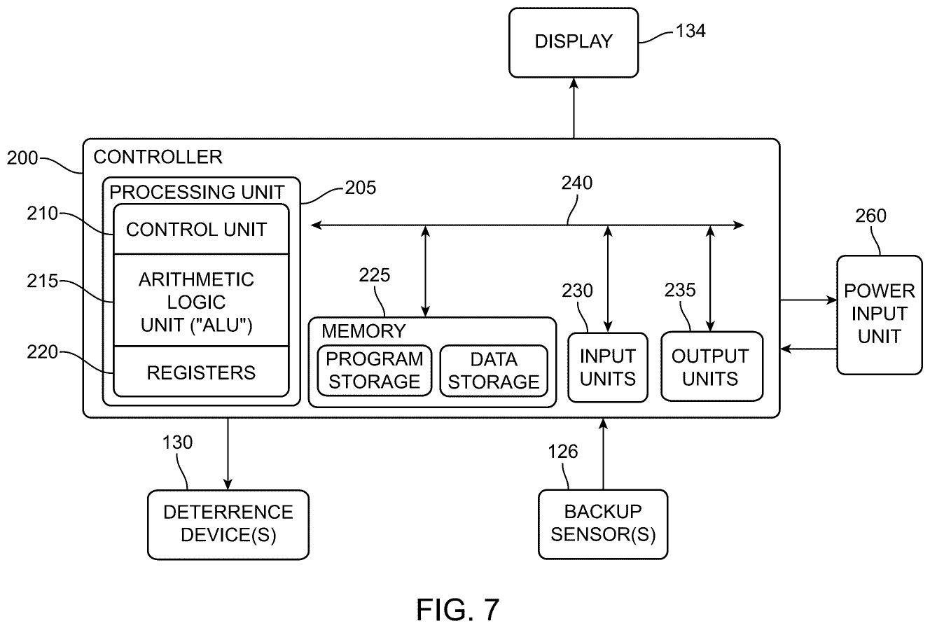

In the illustrated embodiment, the back up sensors 126 include one or more time of flight (ToF) sensors able to measure the distance between the sensor 126 and an object or being by emitting energy and then detecting the energy reflected back by the object or being. For example, the back up sensors 126 may include ultrasonic sensors, infrared sensors, mmWave sensors, and the like. The illustrated back up sensors 126 include a first sensor 142, which is an ultrasonic sensor 142 in the illustrated embodiment, and second sensor 146, which is an infrared (IR) sensor 146 in the illustrated embodiment. The ultrasonic sensor 142 is configured to measure a distance from the rear portion 118 of the equipment 100 to an object 128 within the back up region 138 (FIG. 2). In particular, the ultrasonic sensor 142 includes one or more ultrasonic emitters and one or more receivers that measure an echo (i.e., the return of the sound waves emitted by the one or more ultrasonic emitters) and convert the echo to a sensor signal (e.g., a voltage/current) indicative of a size and position of the object relative to the ultrasonic sensor 142. The sensor signal is then received and processed by a controller 200 (FIG. 7) of the equipment 100, described in greater detail below.

The IR sensor 146 is configured to sense the temperature, size, and/or position of the object 128 within the back up region. In the illustrated embodiment, the IR sensor 146 includes one or more IR light detectors. The IR light detectors may receive IR light emitted by the object 128, which can then be used to determine a temperature of the object 128 and identify whether the temperature of the object 128 is consistent with the temperature of a living being. The IR sensor 146 may also includes one or more IR emitters, which may direct an IR beam having a beam angle between about 5 and 165 degrees. In the illustrated embodiment, the beam angle is between about 15 and 90 degrees. The detector(s) of the IR sensor 146 may sense light reflected back from the object 128 and provide a signal indicative of the size and position of the object 128 relative to the IR sensor 146. In some embodiments, the IR sensor 146 may be used in combination with the ultrasonic sensor 142 (or another ToF sensor) to determine the size and position of the object 128 and whether the object 128 is a living being or an inanimate object.

In some embodiments, the IR sensor 146 may be placed within the frame 110. In such an embodiment, at least a portion of the frame 110 may be transmissive of electromagnetic radiation, specifically transmissive of infrared radiation, so that the IR sensor 146 is placed within the frame while the IR light beam travels through the transmissive frame 110 for the IR sensor 146 to sense the living being. In other embodiments, the IR sensor 146 and the ultrasonic sensor 142 may be provided together in a sensor housing coupled to the frame 110 in any suitable manner.

In some embodiments, the back up sensors 126 may additionally or alternatively include a mmWave radar emitter and sensor, which may be used by the controller 200 to detect objects, their relative position, and determine whether the detected objects are living beings.

In some embodiments, the back up sensors 126 may additionally or alternatively include an optical sensor to distinguish living beings from surrounding plants and objects. The back up sensors 126 may additionally or alternatively include a light sensor. The light sensor detects light of the surrounding area. The light sensor may be implemented using a phototransistor, a photodiode, a photonic integrated circuit, or the like.

In some embodiments, the back up sensors 126 may additionally or alternatively include a vision system with one or more cameras able to detect and recognize objects and beings behind the equipment 100. For example, in such embodiments, the second sensor 146 may include a camera, and the controller 200 may use image processing and artificial intelligence to analyze images from the camera and determine whether a living being is positioned within the field of view of the second sensor 146. In some embodiments, the camera may be used both to determine a relative position of the detected object and whether the detected object is a living being. In some embodiments, the first sensor 142 (e.g., a ToF sensor such as an ultrasonic sensor) may be used by the controller 200 for position and distance determinations.

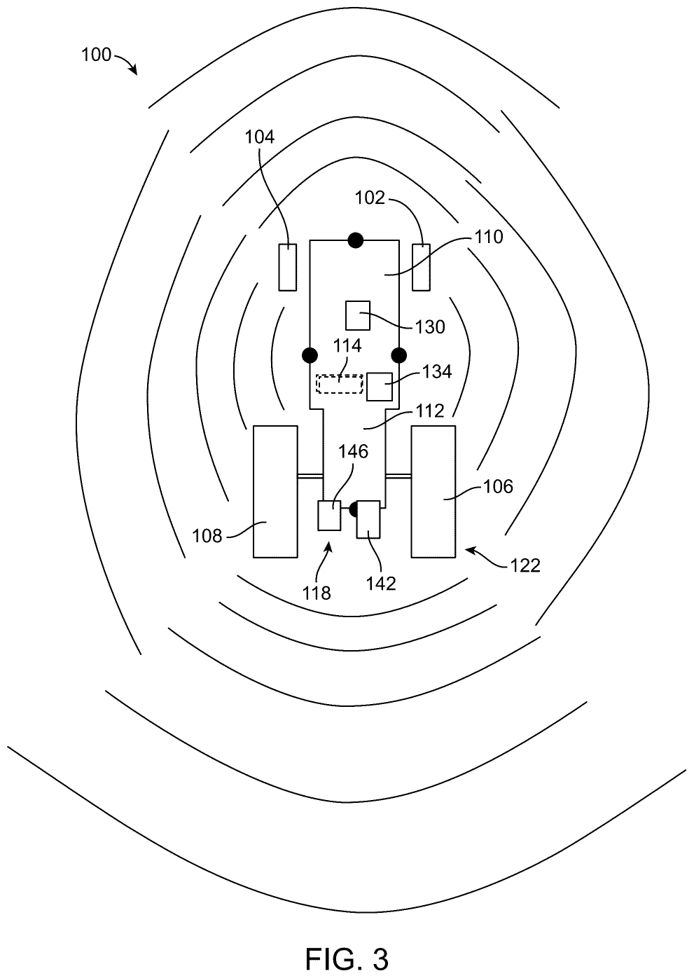

With reference to FIG. 3, the deterrence device 130 of the back up system 122 may be a sound emitting device configured to deter children or animals within a distance range of the equipment 100. The range may include an approximately 10-meter radius surrounding the equipment 100. In other embodiments, the radius may be any radius between 0-meters and 100-meters, for example. The deterrence device 130 is configured to emit sound waves that are of a high frequency, such that only children or animals hear the sound. The frequency of the sound waves is a frequency that is unpleasant to hear such that neither the animal nor the child wishes to be near the source. Specifically, the frequency of the sound emitted by the deterrence device 130 may range from 17,000 Hz to 25,0000 Hz which is a frequency range that is known to effectively deter humans and animals. In some embodiments, the frequency may range from 17,000 Hz to 19,000 Hz, or about 18,000 Hz in some embodiments. The amplitude of the sound waves is controlled such that the sound emitted from the deterrence device 130 may be heard while not causing any permanent hearing damage. In the present embodiment, the deterrence device 130 is mounted to a central portion of the frame 110 to maintain a consistent deterrence range. In alternate embodiments, the equipment 100 may include a plurality of deterrence devices 130 spaced around the frame 110 to extend the range. In the present embodiment, the deterrence device 130 emits a sound when a living being is sensed by the back up sensors 126. The deterrence device 130 continues emitting the sound until the back up sensors 126 no longer sense the living being. In some embodiments, the deterrence device 130 may continuously emit a sound (e.g., when the equipment 100 is operating).

The deterrence device 130 may include a variety of different configurations for emitting the deterrence sound. In some embodiments, the deterrence device 130 includes one or more speakers. In other embodiments, the deterrence device 130 includes one or more piezo buzzers. In yet other embodiments, the deterrence device 130 includes one or more sirens.

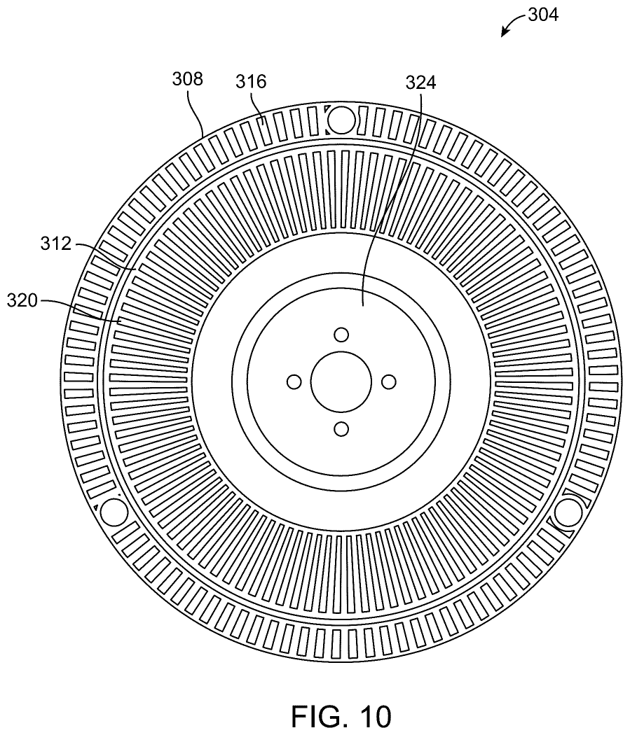

For example, with reference to FIG. 10, a siren 304 that may be incorporated into the deterrence device 130 includes a stator 308 surrounding a rotor or fan 312. The stator 308 includes a first plurality of fins 316 extending in a radial direction and spaced apart around the circumference of the stator 308. The fan 312 includes a second plurality of fins 320 extending in the radial direction and spaced apart around the circumference of the fan 312. The fan 312 also includes a hub 324 attached to a drive, such as an electric motor (not shown). When the fan 312 is driven to rotate within the stator 308, a tone is produced by the siren 304. In the illustrated embodiment, the first plurality of fins 316 and the second plurality of fins 320 are the same in number. In some embodiments, the first and second pluralities of fins 316, 320 may each include between 90-150 fins, or between 110-130 fins in other embodiments. In the illustrated embodiment, the first and second pluralities of fins 316, 320 each include 120 fins. The number of fins 316, 320 and the rotational speed of the fan 312 control the frequency of the tone emitted by the siren 304. In some embodiments, the fan 312 may rotate between 7,000 and 11,000 RPM, and the fan 312 is configured to rotate at about 9,000 RPM in the illustrated embodiment, which provides the desired tone frequency for the deterrence device 130.

Referring to FIGS. 1-3, the display 134 may be positioned adjacent the control unit 114 such that the operator of the equipment 100 may view the display 134 while operating the equipment 100. For example, the display 134 may include a display screen integrated into the equipment 100. In other embodiments, the display 134 may be an indicator located on operating handles (e.g., the control unit 114) of the equipment 100. The operating handles may be used to control forward and reverse operation and/or steering of the equipment 100. In such embodiments, the indicator may include LED light strips applied to or incorporated into the operating handles.

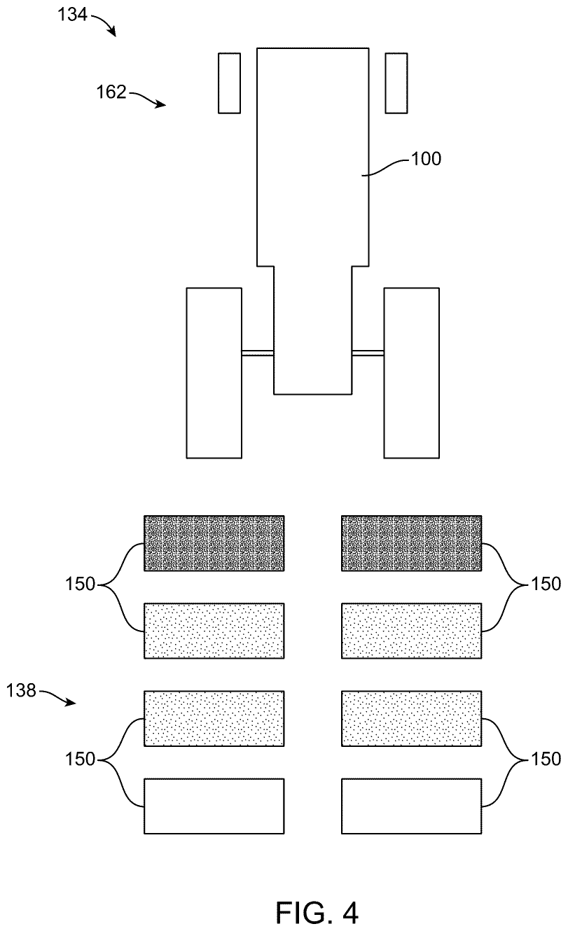

The display 134 is configured to warn the operator of the object 128 in the back up region 138 so that the operator may avoid the object 128. FIGS. 4-6 illustrate exemplary graphics that may be displayed by the display 134 to convey information to the operator of the equipment 100. The illustrated display 134 shows a schematic of the equipment 100 and the back up region 138. The schematic of the back up region 138 may include a grid of symbols or shapes (e.g., eight rectangles 150 organized into two columns, or any other suitable arrangement). The rectangles 150 may be color coded based on a relative distance away from the equipment 100 and may be used to identify the location of the sensed object.

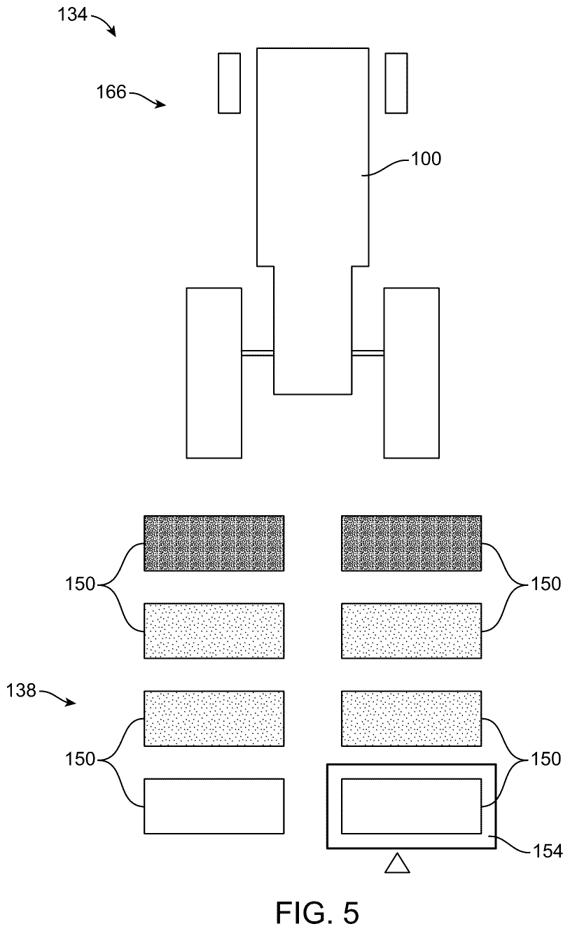

For example, FIG. 4 represents a “No Object Sensed” display configuration 162, which depicts the eight rectangles 150 having a uniform size and shape. Thus, in response to no object being sensed, all eight rectangles 150 are the same shape and size to signify to the operator that an object or living being has not been sensed by the back up sensors 126. FIG. 5 represents an “Object Sensed” display configuration 166, which depicts a larger rectangle or highlighted region 154 overlaid on top of one or several of the rectangles 150. Thus, in response to the back up sensors 126 sensing an object 128 within the back up region 138, the larger rectangle 154 is overlaid on top of whichever of the eight rectangles 150 is closest to the location of the object 128 to alert the operator both that an object was sensed and the general location of the sensed object 128. In the case that the object 128 is located between several rectangles 150 or the object 128 is larger than one of the rectangles 150, then several rectangles 150 may have a larger rectangle overlaid.

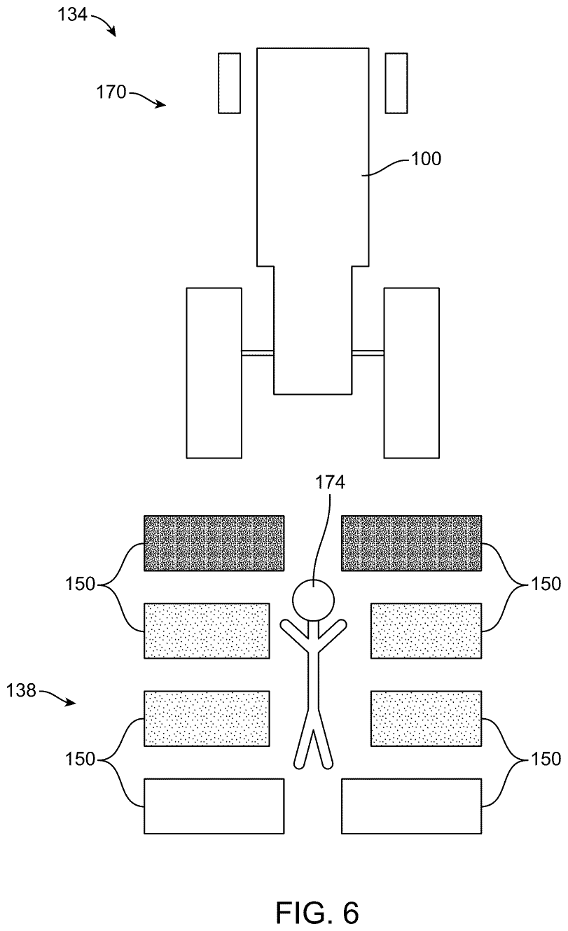

With reference to FIG. 6, the display 134 may also have a warning display configuration 170 if the back up sensors 126 detect a living being within the back up region 138. In the illustrated embodiment, the display may show a person shape 174 between the rectangles 150 in response to the back up sensors 126 sensing a living being within the back up region 138. In some embodiments, the person shape 174 may be positioned over the rectangles 150 at a location corresponding with the sensed position of the living being.

The controller 200 for the equipment 100 will now be described with reference to FIG. 7. The controller 200 is electrically and/or communicatively connected to a variety of modules or components of the equipment 100. For example, the illustrated controller 200 may be connected to the deterrence device 130, a power input unit 260, the back up sensors 126, and the display 134. In some embodiments, the controller 200 may be housed together with the display 134; however, the controller 200 may alternatively be located elsewhere on or within the equipment 100.

The controller 200 includes a plurality of electrical and electronic components that provide power, operational control, and protection to the components and modules within the controller 200 and/or equipment 100. For example, the controller 200 may include, among other things, a processing unit 205 (e.g., a microprocessor, an electronic processor, an electronic controller, a microcontroller, or another suitable programmable device), a memory 225, input units 230, and output units 235. The processing unit 205 may include, among other things, a control unit 210, an arithmetic logic unit (“ALU”) 215, and a plurality of registers 220 implemented using a known computer architecture (e.g., a modified Harvard architecture, a von Neumann architecture, etc.). The processing unit 205, the memory 225, the input units 230, and the output units 235, as well as the various modules connected to the controller 200, may be connected by one or more control and/or data buses.

The memory 225 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 205 is connected to the memory 225 and executes software instructions that are capable of being stored in a RAM of the memory 225 (e.g., during execution), a ROM of the memory 225 (e.g., on a generally permanent basis), or another non-transitory computer readable medium such as another memory or a disc. Software included in the implementation of the equipment 100 can be stored in the memory 225 of the controller 200. The software includes, for example, firmware, one or more applications, program data, filters, rules, one or more program modules, and other executable instructions. The controller 200 is configured to retrieve from the memory 225 and execute, among other things, instructions related to the control processes and methods described herein. In other embodiments, the controller 200 includes additional, fewer, or different components.

The signals from the back up sensors 126 may pass from the input units 230, along control lines (buses) 240, and are processed by the processing unit 205, which then controls the information displayed on the display 134 via the output units 235. The deterrence device 130 is also connected to the controller 200 (via the output units 235) and receives control signals from the controller 200 to turn on and off or otherwise convey information based on different states of the equipment 100. Thus, the controller 200 is programmed to control the deterrence device 130 and the display 134 based on feedback from the back up sensors 126. The controller 200 is further connected to a power input unit 260 to regulate or control the power to and/or from the controller 200.

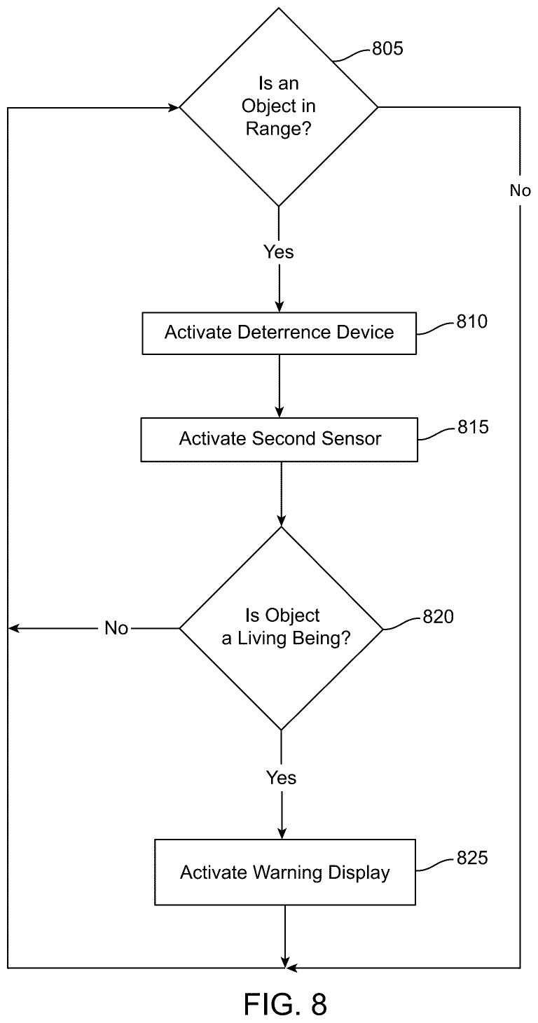

FIGS. 8 illustrates an exemplary method for activating the deterrence device 130 and the display 134. The method may be performed automatically by the controller 200 in some embodiments. The steps of the method are described in an iterative manner for descriptive purposes. Various steps described herein with respect to the method are capable of being executed simultaneously, in parallel, or in an order that differs from the illustrated serial and iterative manner of execution.

At step 805, the controller 200 determines whether an object 128 is in range of the equipment 100. The controller 200 determines if an object 128 is in range of the equipment 100 via the first sensor 142, which senses if the object 128 is within the back up region 138. It should be understood that “in range” means within the back up region 138. In some embodiments, step 805 may include using the second sensor 146 in addition to or in alternative to the first sensor 142. NO goes to step 805, and the display 134 may remain in the “No Object Sensed” configuration 162 shown in FIG. 4. YES goes to step 810. At step 810, in response to determining that the object 128 is in range of the equipment 100, the controller 200 activates the deterrence device 130. Step 810 may additionally or alternatively include illuminating lights (turn signal lights, head lights, brake lights, warning lights, or other indicator lights) in a blinking pattern to draw attention.

Step 810 may additionally or alternatively include activating the “Object Sensed” configuration 166 of the display 134, illustrated in FIG. 5. At step 815, the controller 200 activates the second sensor 146. In some embodiments, other sensors may be activated in addition to the second sensor 146. At step 820, the controller 200 determines whether the object 128 is sensed by the second sensor 146. In response to the object 128 being sensed by the second sensor 146, the controller 200 determines whether a living being is within the back up region 138 (e.g., based on a temperature of the object 128 when the second sensor 146 is an IR sensor, or based on interpreting an image of the object 128 when the second sensor 146 is a camera). NO goes to step 805. YES goes to step 825. At step 825, in response to the object 128 being sensed and determined to be a living being, the controller 200 activates the warning display configuration 170 to indicate to the operator that a living being is within the back up region 138. Once the warning display configuration 170 has been activated, the method returns to step 805. Steps 805, 810, 815, 820, 825 repeat until the object 128 is no longer in range of the equipment 100 (NO at step 805). In some embodiments, the controller 200 may activate the deterrence device 130 only if the controller 200 has determined that the object 128 is a living being (i.e., step 810 may occur after step 820 and together with step 825).

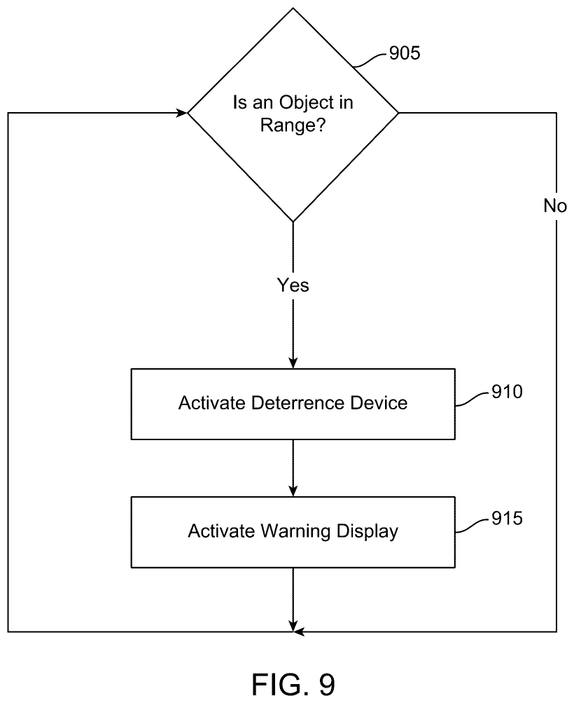

As another example, FIG. 9 provides a second method for activating the back up system 122. The method may be performed automatically by the controller 200. The steps of the method are described in an iterative manner for descriptive purposes. Various steps described herein with respect to the method are capable of being executed simultaneously, in parallel, or in an order that differs from the illustrated serial and iterative manner of execution.

At step 905, the controller 200 determines whether an object 128 is in range of the equipment 100. The controller 200 determines if an object 128 is in range of the equipment 100 via the first sensor 142 which senses if an object 128 is within the back up region 138. In some embodiments, step 905 may include using the second sensor 146 in addition to or in alternative to the first sensor 142. In some embodiments, other sensors may be activated in addition to the second sensor 146. NO goes to step 905. YES goes to step 910. At step 910, in response to determining that an object 128 is in range of the equipment 100, the controller 200 activates the deterrence device 130. At step 915, the controller 200 activates the warning configuration 170 of the display 134. Once the warning configuration 170 has been activated, the method returns to step 905. Steps 905, 910, 915 repeat until the object 128 is no longer in range of the equipment 100 (NO at step 905).

Thus, embodiments described herein provide, among other things, systems, methods, and devices for back up sensing and sound deterrents for lawn equipment. Various features and advantages are set forth in the following claims.

What is claimed is:

1. A back up system for ride-on equipment comprising:
a plurality of back up sensors configured to sense an object within a back up region of the ride-on equipment;
a deterrence device configured to emit a sound;
an indicator; and
a controller configured to:
determine whether the sensed object is within the back up region based on feedback from the plurality of back up sensors, and
activate, in response to determining that the object is within the back up region, the deterrence device and the indicator.

2. The back up system of claim 1, wherein at least one of the plurality of back up sensors is a time of flight sensor.

3. The back up system of claim 1, wherein at least one of the plurality of back up sensors is a camera.

4. The back up system of claim 3, wherein the controller is configured to determine whether the sensed object is a living being based on feedback from the camera.

5. The back up system of claim 4, wherein the controller is configured to activate the deterrence device only if the controller determines that the sensed object is a living being.

6. The back up system of claim 4, wherein the indicator is a display, and wherein the controller is configured to generate a warning on the display to indicate that a living being is within the back up region in response to determining that the sensed object is a living being.

7. The back up system of claim 5, wherein the deterrence device is configured to emit sound waves in a frequency range between 17,000 Hz and 19,000 Hz.

8. The back up system of claim 7, wherein the deterrence device includes a piezo buzzer.

9. The back up system of claim 7, wherein the deterrence device includes a siren having a rotatable fan and a stator surrounding the fan, the stator including a first plurality of fins and the fan including a second plurality of fins.

10. The back up system of claim 9, wherein the first plurality of fins and the second plurality of fins include the same number of fins.

11. The back up system of claim 10, wherein the number of fins is between 90 and 150 fins.

12. The back up system of claim 11, wherein the fan is rotatable relative to the stator at a speed between 7,000 RPM and 11,000 RPM in response to the controller activating the deterrence device.

13. A back up system for ride-on equipment comprising:
a sensor configured to sense an object within a back up region of the ride-on equipment;
a deterrence device configured to emit a sound;
an indicator; and
a controller configured to:
determine whether the sensed object is within the back up region based on feedback from the time of flight sensor, and
activate, in response to determining that the object is within the back up region, the deterrence device and the indicator.

14. The back up system of claim 13, wherein the deterrence device includes a siren having a rotatable fan and a stator surrounding the fan, the stator including a first plurality of fins and the fan including a second plurality of fins.

15. The back up system of claim 13, wherein the sensor includes at least one selected from a group consisting of: a millimeter wave sensor, an ultrasonic sensor, an infrared sensor, and a camera.

16. The back up system of claim 13, wherein the ride-on equipment is a lawn mower including operating handles configured to control forward and reverse movement of the lawn mower, and wherein the indicator is located on the operating handles.

17. A back up system for ride-on equipment comprising:
a plurality of back up sensors configured to sense an object within a back up region of the ride-on equipment, the plurality of back up sensors including at least one camera;
a deterrence device configured to emit sound waves in a frequency range from 17,000 Hz to 19,000 Hz; and
a controller configured to:
determine whether the sensed object is within the back up region based on feedback from the plurality of back up sensors,
determine whether the sensed object is a living being based on feedback from the camera.
activate, in response to determining that the object is within the back up region and that the object is a living being, the deterrence device.

18. The back up system of claim 17, wherein the controller is configured to activate an indicator to indicate that a living being is within the back up region in response to determining that the sensed object is a living being.

19. The back up system of claim 17, wherein the deterrence device includes a siren having a rotatable fan and a stator surrounding the fan, the stator including a first plurality of fins and the fan including a second plurality of fins.

20. The back up system of claim 19, wherein the first plurality of fins and the second plurality of fins include the same number of fins.
